(19) United States
(12) Patent Application Publication
(10) Pub. No.: US 2016/0276915 A1
(43) Pub. Date: Sep. 22, 2016

(54) VIBRATION POWERED GENERATOR

(71) Applicant: KABUSHIKI KAISHA TOSHIBA, Tokyo (JP)

(72) Inventors: Atsuro OONISHI, Yokohama (JP); Akihito OGAWA, Fujisawa (JP)

(21) Appl. No.: 15/062,817

(22) Filed: Mar. 7, 2016

(30) Foreign Application Priority Data
Mar. 20, 2015 (JP) 2015-058344

(51) Int. Cl. H02K 35/00; H02K 11/30; H02K 7/116

(52) U.S. Cl. CPC H02K 35/00; H02K 7/116; H02K 11/30

(57) ABSTRACT

According to one embodiment, a vibration powered generator includes a rotating shaft, a first eccentric weight, a first elastic member, and a first electric generator. The first eccentric weight is connected to the rotating shaft. The first elastic member has a first end part connected to a housing and a second end part connected to the rotating shaft or the first eccentric weight. The first electric generator converts rotational energy of the rotating shaft into electrical energy.

### CROSS-REFERENCE TO RELATED APPLICATIONS

This application is based upon and claims the benefit of priority from Japanese Patent Application No. 2015-058344, filed Mar. 20, 2015, the entire contents of which are incorporated herein by reference.

### FIELD

Embodiments described herein relate generally to a vibration powered generator.

### BACKGROUND

An electromagnetic induction type vibration powered generator that uses a resonance phenomenon generally includes a coil, a vibrating part having a magnetic flux, and a spring supporting the vibrating part. When an environmental vibration is externally applied to the vibration powered generator, the vibrating part makes a relative motion with respect to the coil, and a voltage proportional to the speed is generated in the coil. In a state in which the frequency of the environmental vibration is close to the natural frequency of the vibration powered generator, the amplitude of the vibration of the vibrating part is amplified, and the speed of the vibration also increases. Accordingly, the voltage generated in the coil becomes high, and as a result, the power generation amount is improved.

However, if the vibration of the vibrating part exceeds the prepared range of motion, the vibrating part collides against the housing, and efficient power generation cannot be performed. The vibration powered generator is required to be able to efficiently generate power.

### BRIEF DESCRIPTION OF THE DRAWINGS

FIG. 1 is a sectional view showing a vibration powered generator according to the first embodiment;

FIG. 2 is a sectional view showing a vibration powered generator according to the second embodiment;

FIG. 3 is a view showing a dynamic model for power generation amount calculation according to the third embodiment;

FIG. 4 is view showing contour maps of power generation amounts corresponding to the combinations of mass ratios and resonance frequency ratios according to the third embodiment;

FIG. 5 is a view showing the percentages of S₂/S₁ corresponding to the combinations of mass ratios and resonance frequency ratios according to the third embodiment;

FIG. 6 is a graph showing the range of design parameters that allow a frequency characteristic to widen according to the third embodiment;

FIG. 7A is a graph showing a contour map surrounded by a solid line shown in FIG. 4;

FIG. 7B is a graph showing a power generation amount with respect to the frequency of an environmental vibration in the broken line portion shown in FIG. 7A;

FIG. 8A is a graph showing a contour map surrounded by a broken line shown in FIG. 4;

FIG. 8B is a graph showing a power generation amount with respect to the frequency of an environmental vibration in the broken line portion shown in FIG. 8A;

FIG. 9 is a sectional view showing a vibration powered generator according to the fourth embodiment;

FIGS. 10A and 10B are block diagrams showing an example of the electric circuit of the vibration powered generator according to the fourth embodiment;

FIG. 11A is a graph showing a contour map surrounded by the solid line shown in FIG. 4;

FIG. 11B is a graph showing a power generation amount with respect to the frequency of an environmental vibration in the broken line portion shown in FIG. 11A;

FIG. 11C is a graph showing a power generation amount with respect to the frequency of an environmental vibration in the solid line portion shown in FIG. 11A;

FIG. 12 is a sectional view showing a vibration powered generator according to the fifth embodiment; and

FIG. 13 is a front view showing the vibration powered generator according to the fifth embodiment.

### DETAILED DESCRIPTION

According to one embodiment, a vibration powered generator includes a rotating shaft, a first eccentric weight, a first elastic member, and a first electric generator. The first eccentric weight is connected to the rotating shaft. The first elastic member has a first end part connected to a housing and a second end part connected to the rotating shaft or the first eccentric weight. The first electric generator converts rotational energy of the rotating shaft into electrical energy.

The embodiments will hereinafter be described with reference to the accompanying drawings. A vibration powered generator according to an embodiment can extract power from an environmental vibration using a resonance phenomenon. In the following embodiments, the like reference numerals denote the like elements, and a repetitive description thereof will appropriately be omitted.

### First Embodiment

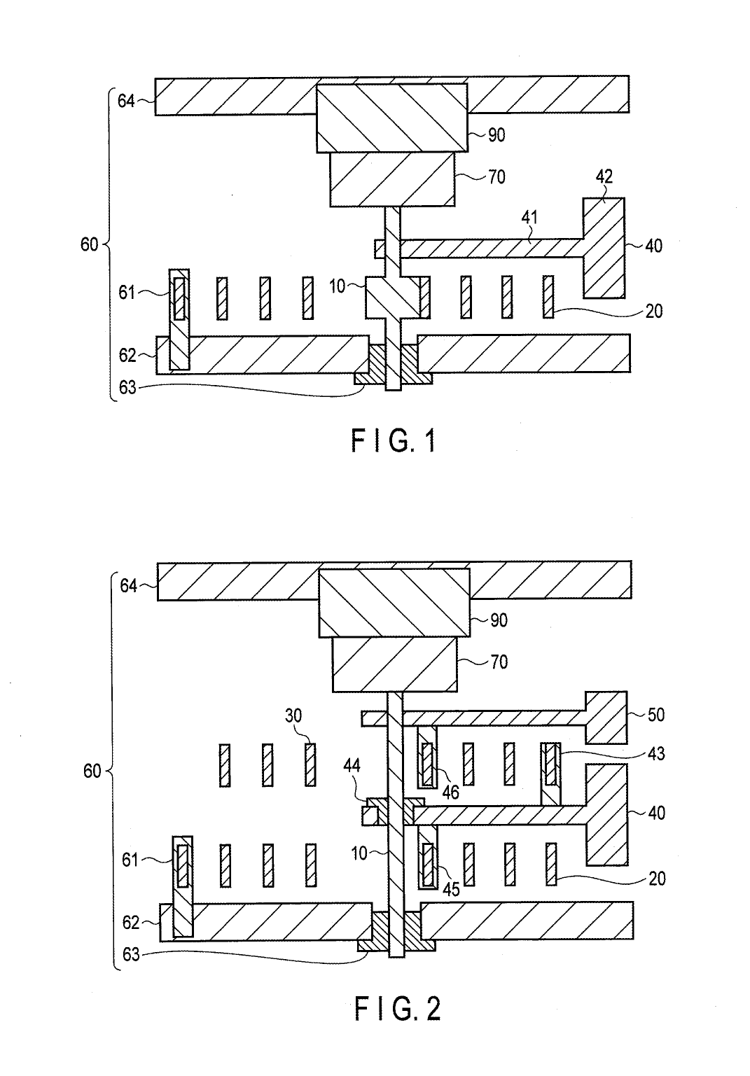

FIG. 1 is a sectional view schematically showing a vibration powered generator according to the first embodiment. The vibration powered generator shown in FIG. 1 includes a rotating shaft 10, an elastic member 20, an eccentric weight 40, a housing (or a case) 60, a speed increaser 70, and an electric generator 90.

The housing 60 houses the rotating shaft 10, the elastic member 20, the eccentric weight 40, the speed increaser 70, and the electric generator 90. The housing 60 has, for example, a hollow cylindrical shape. The housing 60 includes a bottom part 62, a top part 64 opposed to the bottom part 62, a cylindrical part (not shown) that connects the bottom part 62 and the top part 64, a fixing part 61 provided on the bottom part 62, and a bearing (rotating component) 63 provided on the bottom part 62.

One end part of the rotating shaft 10 is supported by the bottom part 62 of the housing 60 via the bearing 63, and the other end part is connected to the speed increaser 70. The bearing 63 rotatably supports the rotating shaft 10. The speed increaser 70 is connected to the electric generator 90, and the electric generator 90 is attached to the top part 64 of the housing 60.

The eccentric weight 40 is attached to the rotating shaft 10. The eccentric weight 40 rotates together with the rotating shaft 10. The eccentric weight 40 is formed into, for example, a shape that increases the weight as the distance from the rotating shaft 10 increases. For example, the eccentric weight 40 viewed from the direction of the rotating shaft 10 has a sectoral shape and is formed such that a part 42 located outside is thicker than a part 41 located inside (on the side of the rotating shaft 10) and fixed to the rotating shaft 10. The thickness indicates the dimension in the direction of the rotating shaft 10.

One end part of the elastic member 20 is connected to the rotating shaft 10, and the other end part is connected to the fixing part 61 of the housing 60. In the example shown in FIG. 1, the elastic member 20 is a spiral spring. The elastic member 20 applies an elastic force to the rotating shaft 10 in a direction reverse to the rotation direction of the rotating shaft 10. The eccentric weight 40 thus swings about the rotating shaft 10.

Note that one end part of the elastic member 20 may be connected to the eccentric weight 40 in place of the rotating shaft 10. In this case, for example, one end part of the elastic member 20 is connected to the eccentric weight 40 via a fixing part (not shown).

The speed increaser 70 increases the rotational speed of the rotating shaft 10 and transmits rotation having the increased rotational speed to the electric generator 90. The electric generator 90 converts the rotational energy of the rotating shaft 10 into electrical energy. The electric generator 90 generates power based on the rotation increased in speed by the speed increaser 70. As the electric generator 90, it is possible to utilize, for example, an electromagnetic induction type generator such as a dynamo or an electrostatic induction type generator.

When an external environmental vibration is applied to the eccentric weight 40, the eccentric weight 40 swings. According to the swing of the eccentric weight 40, the rotating shaft 10 pivots, and the electric generator 90 generates power. If a natural frequency determined by the moment of inertia of the eccentric weight 40 and the spring constant of the elastic member 20 is close to the frequency of the environmental vibration, resonance occurs, and the swing motion of the eccentric weight 40 is amplified. This improves the power generation amount. In a case in which, for example, a spiral spring is used as the elastic member 20, even when the swing motion is amplified, collision between the housing 60 and the eccentric weight 40 never occurs because of the structure. As a result, efficient power generation is possible.

As described above, the vibration powered generator according to the present embodiment includes the rotating shaft, the eccentric weight connected to the rotating shaft, the elastic member connecting the rotating shaft to the housing, and the electric generator converting the rotational energy of the rotating shaft into electrical energy. According to this structure, the swing motion of the eccentric weight is amplified by resonance. In addition, the eccentric weight never collides against the housing. As a result, power generation can efficiently be performed.

### Modification of First Embodiment

When the speed increaser 70 is provided, the power generation amount can be expected to increase along with an increase in the electrical damping ratio. On the other hand, the mechanical damping ratio inevitably increases. For this reason, there is a concern about a decrease in the power generation amount as a decrease in the rotation speed is caused by the increase in the mechanical damping ratio. Hence, the merit and demerit of providing the speed increaser 70 have tradeoff relationships.

The electrical damping ratio can also be increased by improving the magnetic characteristic of a magnetic circuit in the electric generator 90. To improve the magnetic characteristic of the magnetic circuit, more magnets or core materials with excellent magnetic characteristics are used. Hence, if the tolerance for the size and cost of the vibration powered generator is high, a design without the speed increaser 70 is possible.

### Second Embodiment

FIG. 2 is a sectional view schematically showing a vibration powered generator according to the second embodiment. The vibration powered generator shown in FIG. 2 includes a rotating shaft 10, an elastic member 20, an elastic member 30, an eccentric weight 40, an eccentric weight 50, a housing 60, an speed increaser 70, and an electric generator 90.

The housing 60 houses the rotating shaft 10, the elastic member 20, the elastic member 30, the eccentric weight 40, the eccentric weight 50, the speed increaser 70, and the electric generator 90. The housing 60 includes a bottom part 62, a top part 64 opposed to the bottom part 62, a cylindrical part (not shown) that connects the bottom part 62 and the top part 64, a fixing part 61 provided on the bottom part 62, and a bearing 63 provided on the bottom part 62.

One end part of the rotating shaft 10 is supported by the bottom part 62 of the housing 60 via the bearing 63, and the other end part is connected to the speed increaser 70. The speed increaser 70 is connected to the electric generator 90, and the electric-generator 90 is attached to the top part 64 of the housing 60.

The eccentric weight 40 is connected to the rotating shaft 10 via a bearing 44. That is, the eccentric weight 40 is connected to the rotating shaft 10 so as to be rotatable with respect to the rotating shaft 10. The eccentric weight 40 is provided with a fixing part 43 and a fixing part 45. The eccentric weight 50 is attached to the rotating shaft 10. The eccentric weight 50 rotates together with the rotating shaft 10. The eccentric weight 50 is provided with a fixing part 46. Each of the eccentric weights 40 and 50 has, for example, a shape that increases the weight as the distance from the rotating shaft 10 increases.

One end part of the elastic member 20 is connected to the eccentric weight 40 via the fixing part 45, and the other end part is connected to the fixing part 61 of the housing 60. One end part of the elastic member 30 is connected to the eccentric weight 50 via the fixing part 46, and the other end part is connected to the eccentric weight 40 via the fixing part 43. Note that one end part of the elastic member 30 may be connected to the rotating shaft 10 in place of the eccentric weight 50. In the example shown in FIG. 2, the elastic members 20 and 30 are spiral springs. When the elastic members 20 and 30 are provided, the eccentric weights 40 and 50 swing or vibrate about the rotating shaft 10.

The speed increaser 70 increases the rotational speed of the rotating shaft 10 and transmits rotation having the increased rotational speed to the electric generator 90. The electric generator 90 converts the rotational energy of the rotating shaft 10 into electrical energy. The electric generator 90 generates power based on the rotation increased in speed by the speed increaser 70. As the electric generator 90, it is possible to utilize, for example, an electromagnetic induction type generator or an electrostatic induction type generator. Note that a design without the speed increaser 70 is also possible due to the same reason as described in the modification of the first embodiment.

When an external environmental vibration is applied to the vibration powered generator shown in FIG. 2, the eccentric weights 40 and 50 swing. According to the swing of the eccentric weights 40 and 50, the rotating shaft 10 pivots, and the electric generator 90 generates power. If one of a first natural frequency determined by the moment of inertia of the eccentric weight 40 and the spring constant of the elastic member 20 and a second natural frequency determined by the moment of inertia of the eccentric weight 50 and the spring constant of the elastic member 30 is close to the frequency of the environmental vibration, resonance occurs, and the swing motions of the eccentric weights 40 and 50 are amplified. Even when the swing motions of the eccentric weights 40 and 50 are amplified, the eccentric weights 40 and 50 never collide against the housing 60 because of the structure. As a result, efficient power generation is possible.

The vibration powered generator according to this embodiment can be mounted on, for example, a terminal apparatus carried by a person. The frequency of human walking and the frequency of running are known to be about 2 Hz and 3 Hz, respectively. Hence, a vibration powered generator capable of efficiently generating power in both human walking and running can be implemented by designing the first natural frequency and the second natural frequency to about 2 Hz and 3 Hz, respectively.

When the frequency characteristic of the vibration powered generator is made moderate by increasing the electroviscous coefficient, the vibration powered generator can cope with even the difference in the walking or running frequency between users. When data is obtained by statistically ordering human waking and running frequencies, an optimum vibration powered generator for the data can be designed.

The vibration powered generator according to this embodiment is also effective for a vibration system on which an environmental vibration other than the vibration of human waking and running acts. For example, the vibration powered generator is effective for a vibration system having two or more vibration modes.

As described above, the vibration powered generator according to the present embodiment includes the rotating shaft, the first eccentric weight connected to the rotating shaft via the bearing, the second eccentric weight connected to the rotating shaft, the first elastic member which connects the rotating shaft to a housing, the second elastic member which connects the first eccentric weight to the housing, and the electric generator which converts the rotational energy of the rotating shaft into electrical energy. According to this structure, the swing motions of the first eccentric weight and the second eccentric weight are amplified by resonance. In addition, the first eccentric weight and the second eccentric weight never collide against the housing. Furthermore, the frequency characteristic can be widened by providing the plurality of eccentric weights. As a result, power generation can efficiently be performed.

### Third Embodiment

In the third embodiment, design conditions necessary for making the vibration powered generator according to the second embodiment have a wide frequency characteristic will be described.

Let M₁ be the mass of an eccentric weight 40, M₂ be the mass of an eccentric weight 50, Fn₁ be a resonance frequency determined by the eccentric weight 40 and an elastic member 20, and Fn₂ be a resonance frequency determined by the eccentric weight 50 and an elastic member 30. Design parameters in a vibration powered generator are a mass ratio (M₂/M₁), a resonance frequency ratio (Fn₂/Fn₁), and an electrical damping ratio. Power generation amounts are calculated comprehensively for these parameters.

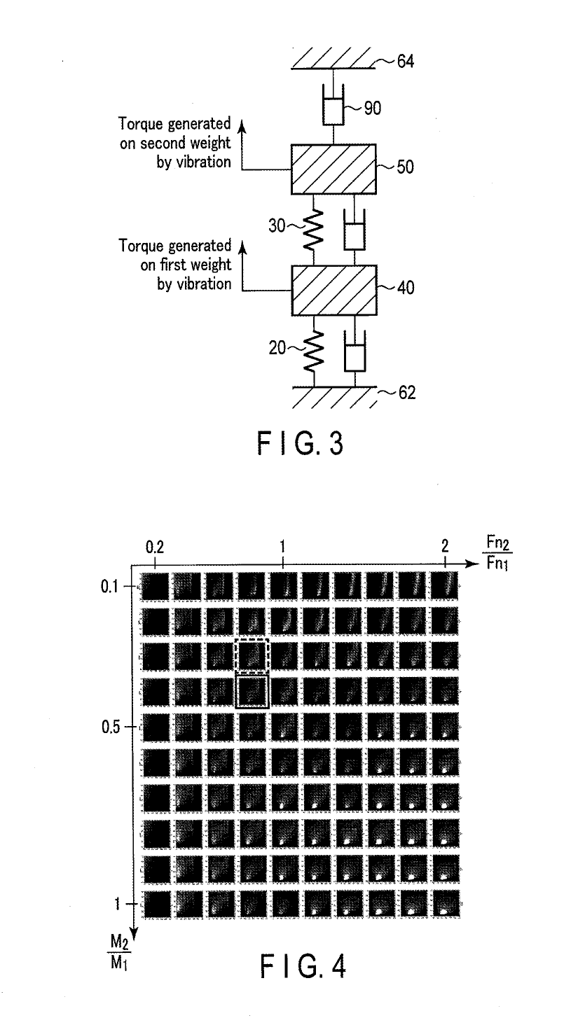

FIG. 3 schematically shows a dynamic model used for power generation amount calculation. FIG. 3 shows the dynamic model as a translational model because an illustration along the rotation direction is complicated and difficult to perceive. Modeling is done assuming an electric generator 90 as an electroviscosity. Calculation is performed assuming that the power generation amount is equivalent to energy consumption by the electroviscosity.

FIG. 4 shows a calculation result obtained for human walking and running. Assuming that the frequencies of human walking and running are 2 Hz and 3 Hz, the frequency of an environmental vibration is calculated within the range of 1 to 4 Hz. Referring to FIG. 4, contour maps are arranged along the abscissa representing the mass ratio (M₂/M₁) and the ordinate representing the resonance frequency ratio (Fn₂/Fn₁). For example, a contour map surrounded by a solid line is a contour map obtained in a case in which the mass ratio is 0.4, and the resonance frequency ratio is 0.8. Each contour map represents a power generation amount when the horizontal axis represents the frequency of the environmental vibration, and the vertical axis represents the electrical damping ratio. In the contour map, the closer to white the color is, the larger the power generation amount is.

An index used to determine the design conditions necessary for making the vibration powered generator have a wide frequency characteristic will be described here. Let Wₘₐₓ be the maximum power generation amount in all contour maps shown in FIG. 4, S₁ be the area of a region obtained by extracting range from 2 Hz corresponding to the walking frequency to 3 Hz corresponding to the running frequency in each contour map, and S₂ be the area of a region where the power generation amount is equal to or more than 35% of the maximum power generation amount Wₘₐₓ in the extracted region.

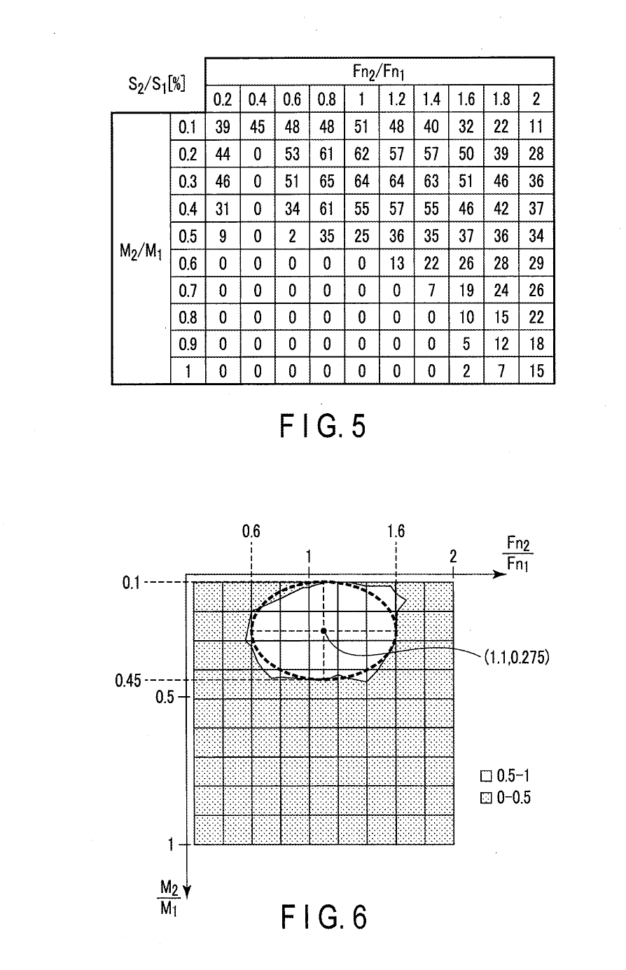

First, S₂/S₁ is calculated for each contour map. FIG. 5 shows the calculation result. In FIG. 5, the percentages of S₂/S₁ are shown in correspondence with the mass ratios (M₂/M₁) and the resonance frequency ratios (Fn₂/Fn₁). Here, as a performance index used to design a vibration powered generator having a wide frequency characteristic, the percentage of S₂/S₁ is assumed to be 50% or more. When this index is applied to FIG. 5, the ranges of design parameters are determined as shown in FIG. 6. In FIG. 6, a region where the percentage of S₂/S₁ is 50% or more is indicated by white, and a region where the percentage of S₂/S₁ is less than 50% is indicated by gray.

Referring to FIG. 6, when the white region is regarded as an ellipse, the equation of the ellipse can be given by

$$\frac{{( \frac{{Fn}_{2}}{{Fn}_{1}} - 1.1 )}^{2}}{{0.5}^{2}} + \frac{{( \frac{{M}_{2}}{{M}_{1}} - 0.275 )}^{2}}{{0.175}^{2}} \leq 1 \qquad ( 1 )$$

Hence, the frequency characteristic of the vibration powered generator is widened under conditions that the mass ratio (M₂/M₁) and the resonance frequency ratio (Fn₂/Fn₁) meet inequality (1).

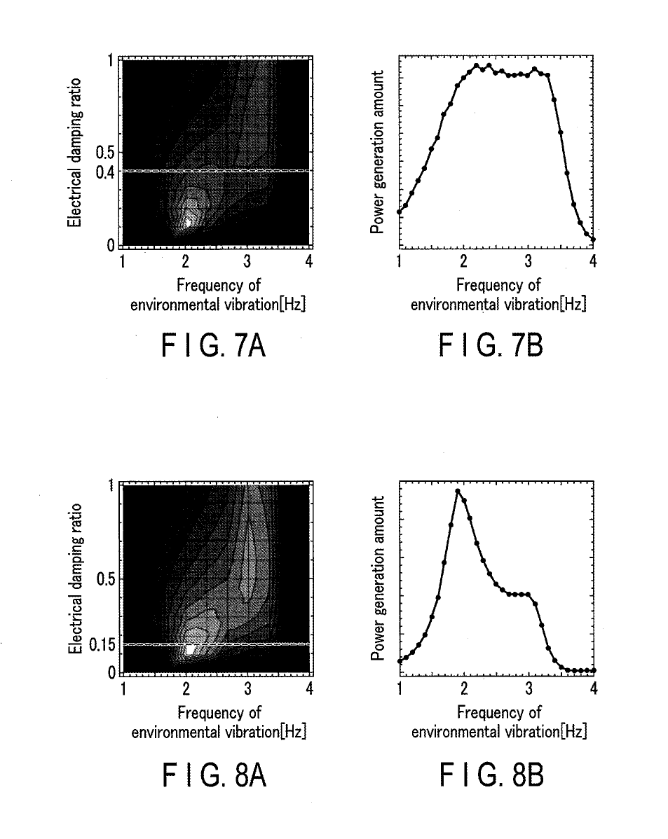

An example of calculation when designing the vibration powered generator to meet inequality (1) will be described. FIG. 7A is an enlarged view of the contour map surrounded by the solid line in FIG. 4. FIG. 7B is a graph showing a power generation amount with respect to the frequency of an environmental vibration in the broken line portion shown in FIG. 7A. As can be seen from FIG. 7B, the frequency characteristic of the power generation amount is widened with respect to the walking frequency of 2 Hz and the running frequency of 3 Hz.

FIG. 8A is an enlarged view of the contour map surrounded by the broken line in FIG. 4. FIG. 8B is a graph showing a power generation amount with respect to the frequency of an environmental vibration in the broken line portion shown in FIG. 8A. When the vibration powered generator has the frequency characteristic of the power generation amount as shown in FIG. 8B, even in a system in which the acceleration is small at a low frequency (walking) and large at a high frequency (running), for example, in human walking and running, the frequency characteristic of the output power generation amount can be widened and flattened.

Even in a case other than walking and running, a vibration powered generator having a wide frequency characteristic can be designed by selecting the design parameters within a range to meet inequality (1) in accordance with the frequency characteristic of the acceleration of an environmental vibration.

### Fourth Embodiment

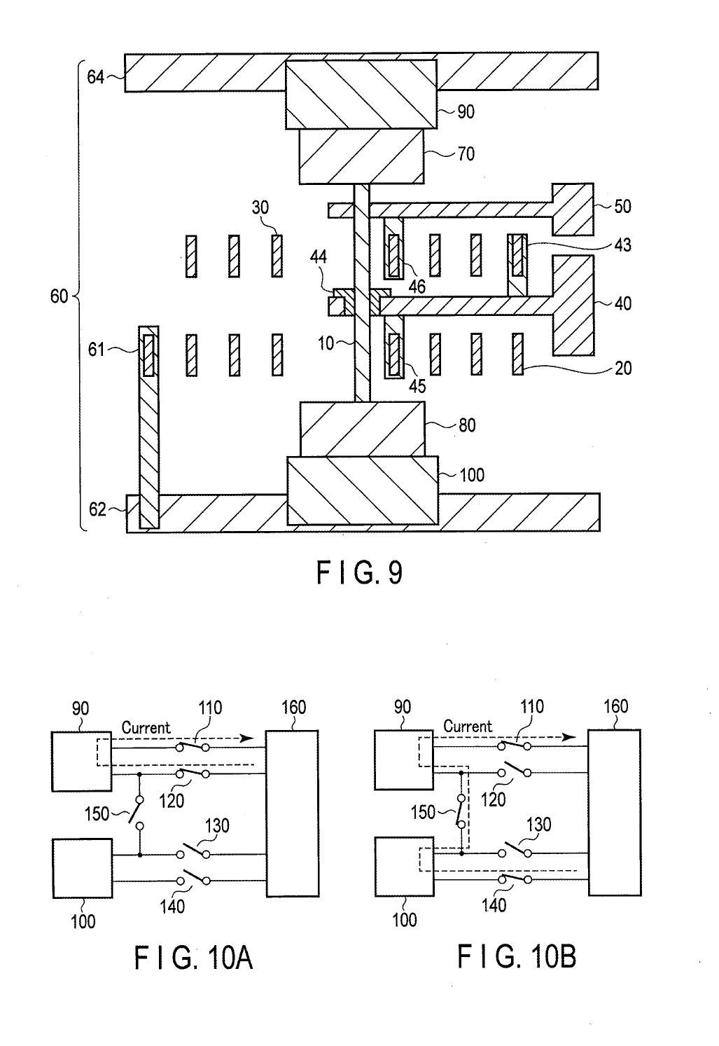

FIG. 9 is a sectional view schematically showing a vibration powered generator according to the fourth embodiment. The vibration powered generator shown in FIG. 9 includes a rotating shaft 10, an elastic member 20, an elastic member 30, an eccentric weight 40, an eccentric weight 50, a housing 60, an speed increaser 70, an speed increaser 80, an electric generator 90, and an electric generator 100. The vibration powered generator shown in FIG. 9 corresponds to the vibration powered generator shown in FIG. 2 to which the speed increaser 80 and the electric generator 100 are added. In this embodiment, a description of the same parts as in the second embodiment will be omitted, and points changed from the second embodiment will be described.

The housing 60 houses the rotating shaft 10, the elastic member 20, the elastic member 30, the eccentric weight 40, the eccentric weight 50, the speed increaser 70, the speed increaser 80, the electric generator 90, and the electric generator 100. The housing 60 includes a bottom part 62, a top part 64 facing the bottom part 62, a cylindrical part (not shown) that connects the bottom part 62 and the top part 64, and a fixing part 61 provided on the bottom part 62.

One end part of the rotating shaft 10 is connected to the speed increaser 80, and the other end part is connected to the speed increaser 70. The speed increaser 80 is connected to the electric generator 100, and the electric generator 100 is attached to the bottom part 62 of the housing 60. The speed increaser 80 increases the rotational speed of the rotating shaft 10 and transmits rotation having the increased rotational speed to the electric generator 100. The electric generator 100 converts the rotational energy of the rotating shaft 10 into electrical energy. The electric generator 100 generates power based on the rotation increased in speed by the speed increaser 80. As the electric generator 100, it is possible to utilize, for example, an electromagnetic induction type generator or a static induction type generator. Note that a design without the speed increasers 70 and 80 is also possible due to the same reason as described in the modification of the first embodiment.

FIGS. 10A and 10B schematically show an electric connection circuit to which the electric generators 90 and 100 are connected. As shown in FIGS. 10A and 10B, the electric connection circuit includes switches 110, 120, 130, 140, and 150, and a power extraction circuit 160. The switches 110, 120, 130, 140, and 150 can be either mechanical switches or electrical switches.

The switch 110 is provided on a first line that electrically connects the electric generator 90 and the power extraction circuit 160. The switch 120 is provided on a second line that electrically connects the electric generator 90 and the power extraction circuit 160. The switch 130 is provided on a third line that electrically connects the electric generator 100 and the power extraction circuit 160. The switch 140 is provided on a fourth line that electrically connects the electric generator 100 and the power extraction circuit 160. The switch 150 is provided on a fifth line that electrically connects the second line and the third line.

FIG. 10A shows a state in which the switches 110 and 120 are ON, and the switches 130, 140, and 150 are OFF. In this state, a current flowing to the power extraction circuit 160 is generated by the electric generator 90. FIG. 10B shows a state in which the switches 110, 140, and 150 are ON, and the switches 120 and 130 are OFF. In this state, a current flowing to the power extraction circuit 160 is generated by the electric generators 90 and 100. That is, two levels of electroviscosity can be selected by ON/OFF-controlling the switches 110, 120, 130, 140, and 150.

Note that when a number of power generation coils are placed in the electric generator, and connection of the leads of the coils is changed, multiple levels of electroviscosity can be selected. In this case, the multiple levels of electroviscosity can be selected even in a vibration powered generator including one electric generator, as in the first embodiment. The selection is executed based on, for example, the frequency of an environmental vibration. The frequency of an environmental vibration can be detected using, for example, an acceleration sensor.

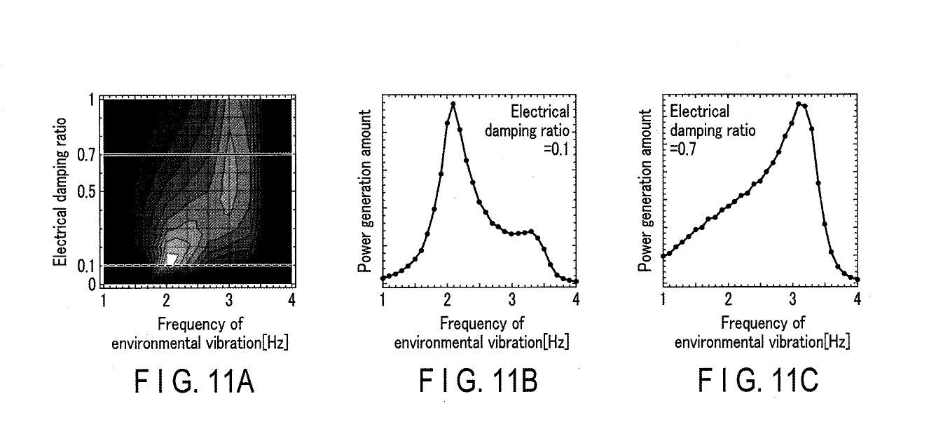

FIG. 11A is an enlarged view of the contour map surrounded by the solid line in FIG. 4. FIG. 11B is a graph showing a power generation amount with respect to the frequency of an environmental vibration in the broken line portion (when the electrical damping ratio is 0.1) shown in FIG. 11A. FIG. 11C is a graph showing a power generation amount with respect to the frequency of an environmental vibration in the solid line portion (when the electrical damping ratio is 0.7) shown in FIG. 11A.

As shown in FIG. 11B, when the electroviscosity is small, the peak of the power generation amount appears when the frequency of the environmental vibration is about 2 Hz. On the other hand, as shown in FIG. 11C, when the electroviscosity is large, the peak of the power generation amount appears when the frequency of the environmental vibration is about 3 Hz. Thus, changing the electroviscosity corresponds to adjusting the frequency characteristic of the vibration powered generator. For example, the vibration powered generator is set in the state shown in FIG. 11B at the time of human walking. The vibration powered generator is set in the state shown in FIG. 11C at the time of running. This enables efficient power generation in both walking and running.

In addition, since the resonance frequency of the vibration powered generator can be adjusted by turning on/off the switches, power necessary for the adjustment is small.

As described above, the vibration powered generator according to this embodiment is formed by adding an electric generator to the vibration powered generator according to the second embodiment. Multiple levels of electroviscosity can thus be selected. As a result, power generation can be performed more efficiently.

### Fifth Embodiment

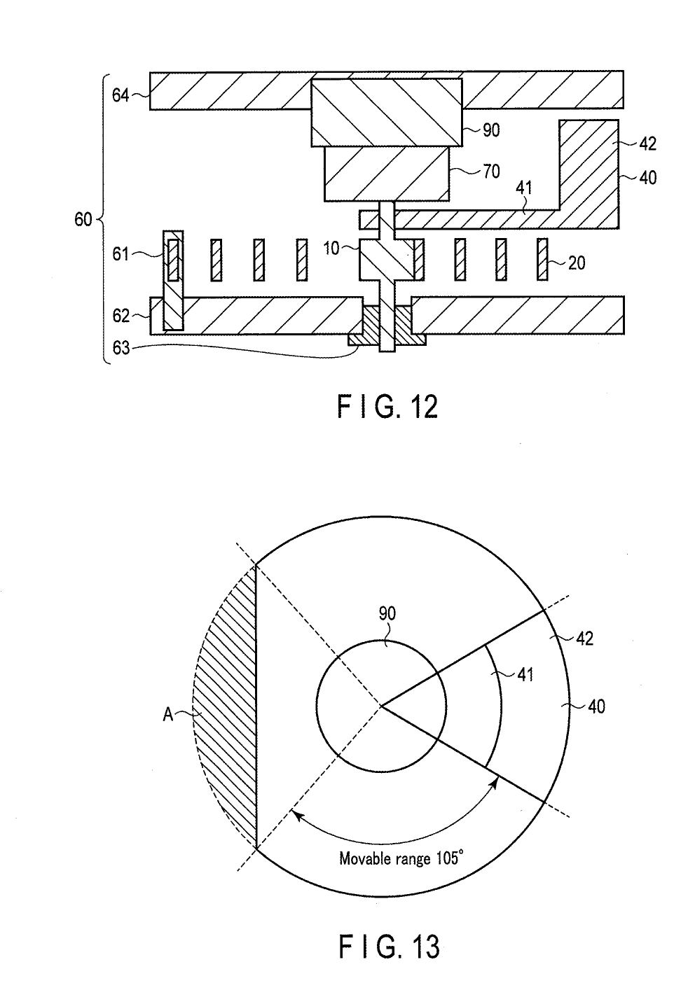

FIG. 12 is a sectional view schematically showing a vibration powered generator according to the fifth embodiment. The vibration powered generator shown in FIG. 12 includes the same constituent elements as the vibration powered generator shown in FIG. 1. In the fifth embodiment, the shape and arrangement of an eccentric weight 40 are different from the first embodiment. In the first embodiment, the eccentric weight 40 has a T-shaped section, as shown in FIG. 1. On the other hand, in the fifth embodiment, the eccentric weight 40 has an L-shaped section, as shown in FIG. 12. This makes it possible to arrange the eccentric weight 40 such that a distal part 42 of the eccentric weight 40 faces parts of a speed increaser 70 and an electric generator 90. As a result, the vibration powered generator can be made thin. In addition, an elastic member 20 may be arranged between the eccentric weight 40 and the speed increaser 70.

FIG. 13 is a front view schematically showing the vibration powered generator according to this embodiment. In FIG. 13, a housing 60, a rotating shaft 10, the elastic member 20, and the speed increaser 70 are not illustrated. As can be seen from a result of power generation amount analysis, a rotation amount θb of the eccentric weight 40 is saturated at about 105° even if the acceleration of the external vibration increases to some extent. Accordingly, the eccentric weight 40 does not reach a region A shown in FIG. 13. For this reason, the region A is an unnecessary space. Hence, when the housing is formed into a shape without the space, downsizing of the vibration powered generator can be implemented. Alternatively, the space may be used to arrange an attached structure such as an electric circuit.

A vibration powered generator according to at least one of the above-described embodiments includes a rotating shaft, an eccentric weight connected to the rotating shaft, an elastic member configured to connect the rotating shaft to a housing, and an electric generator configured to convert rotational energy of the rotating shaft into electrical energy. According to this structure, the swing motion of the eccentric weight is amplified by resonance, and the eccentric weight never collides with the housing. As a result, power generation can efficiently be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vibration powered generator comprising:
a rotating shaft;
a first eccentric weight connected to the rotating shaft;
a first elastic member having a first end part connected to a housing and a second end part connected to the rotating shaft or the first eccentric weight; and
a first electric generator converting rotational energy of the rotating shaft into electrical energy.

2. The vibration powered generator according to claim 1, further comprising a speed increaser that increases a rotational speed of the rotating shaft and transmits rotation having the increased rotational speed to the first electric generator,
wherein the rotating shaft is connected to the first electric generator via the speed increaser, and the first electric generator comprises an electromagnetic induction type generator.

3. The vibration powered generator according to claim 1, further comprising a second eccentric weight connected to the rotating shaft; and
a second elastic member having a first end part connected to the first eccentric weight and a second end part connected to the rotating shaft or the second eccentric weight,
wherein the second end part of the first elastic member is connected to the first eccentric weight.

4. The vibration powered generator according to claim 3, wherein a ratio of a mass of the first eccentric weight to a mass of the second eccentric weight and a ratio of a resonance frequency determined by the first eccentric weight and the first elastic member to a resonance frequency determined by the second eccentric weight and the second elastic member are determined to meet a condition that a region where a power generation amount is not less than 35% of a maximum power generation amount accounts for 50% of a whole region in a range where a frequency of an environmental vibration ranges from 2 Hz to 3 Hz in a graph of the power generation amount in which an electrical damping ratio and the frequency of the environmental vibration are set along two axes.

5. The vibration powered generator according to claim 3, wherein M₁, M₂, Fn₁, and Fn₂ meet
$$\frac{{( \frac{{Fn}_{2}}{{Fn}_{1}} - 1.1 )}^{2}}{{0.5}^{2}} + \frac{{( \frac{{M}_{2}}{{M}_{1}} - 0.275 )}^{2}}{{0.175}^{2}} \leq 1 ,$$
where M₁ is a mass of the first eccentric weight, M₂ is a mass of the second eccentric weight, Fn₁ is a resonance frequency determined by the first eccentric weight and the first elastic member, and Fn₂ is a resonance frequency determined by the second eccentric weight and the second elastic member.

6. The vibration powered generator according to claim 3, wherein the first electric generator includes a plurality of coils, and a coil to be used for power generation is selected from the plurality of coils in accordance with a frequency of an environmental vibration.

7. The vibration powered generator according to claim 1, further comprising a second electric generator converting the rotational energy of the rotating shaft into electrical energy; and
a selector selecting, from the first electric generator and the second electric generator, at least one electric generator to be electrically connected to a power extraction circuit.
